(19) United States
(12) Patent Application Publication
(10) Pub. No.: US 2013/0176866 A1
(43) Pub. Date: Jul. 11, 2013

(54) CALL RECOVERY IN TD-SCDMA HANDOVER FAILURE

(71) Applicants: Ming Yang, San Diego, CA (US); Tom Chin, San Diego, CA (US); Qingxin Chen, Del Mar, CA (US); Guangming Shi, San Diego, CA (US)

(72) Inventors: Ming Yang, San Diego, CA (US); Tom Chin, San Diego, CA (US); Qingxin Chen, Del Mar, CA (US); Guangming Shi, San Diego, CA (US)

(21) Appl. No.: 13/344,441

(22) Filed: Jan. 5, 2012

(51) Int. Cl. H04W 24/00; H04W 36/00

(52) U.S. Cl. 370/252

(57) ABSTRACT

A method of wireless communication includes measuring and recording a path loss of a first downlink signal from a source base station, prior to attempting handoff from the source base station to a target base station. The path loss of a second downlink signal from the source base station is measured after unsuccessful handoff from the source base station to the target base station. A UE communicates with the source base station, after unsuccessful handoff, using an uplink timing corresponding to an uplink timing recorded prior to attempting handoff when a difference between the path loss of the first downlink signal and the path loss of the second downlink signal fails to meet a threshold value. A new uplink timing is used when the difference meets the threshold value.

### BACKGROUND

1. Field

Aspects of the present disclosure relate, in general, to wireless communication systems, and more particularly, to call recovery in TD-SCDMA communications systems.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of communicating in a wireless network is disclosed. The method includes measuring and recording a path loss of a first downlink signal from a source base station, prior to attempting handoff from the source base station to a target base station. The method also includes measuring a path loss of a second downlink signal from the source base station, after unsuccessful handoff from the source base station to the target base station. The method also includes communicating with the source base station, after unsuccessful handoff, using an uplink timing corresponding to an uplink timing recorded prior to attempting handoff when the difference between the path loss of the first downlink signal and the path loss of the second downlink signal fails to meet a threshold value, and using a new uplink timing when the difference meets the threshold value.

Another aspect discloses an apparatus for communicating in a wireless network and includes means for measuring and recording a path loss of a first downlink signal from a source base station, prior to attempting handoff from the source base station to a target base station. The apparatus also includes means for measuring a path loss of a second downlink signal from the source base station, after unsuccessful handoff from the source base station to the target base station. The apparatus also includes means for communicating with the source base station, after unsuccessful handoff, using an uplink timing corresponding to an uplink timing recorded prior to attempting handoff when a difference between the path loss of the first downlink signal and the path loss of the second downlink signal fails to meet a threshold value. A new uplink timing is used when the difference meets the threshold value.

In another aspect, a wireless network having a memory and at least one processor coupled to the memory is disclosed. The processor(s) is configured to measure and record a path loss of a first downlink signal from a source base station, prior to attempting handoff from the source base station to a target base station. The processor(s) is also configured to measure a path loss of a second downlink signal from the source base station, after unsuccessful handoff from the source base station to the target base station. The processor(s) is configured to communicate with the source base station, after unsuccessful handoff, using an uplink timing corresponding to an uplink timing recorded prior to attempting handoff when a difference between the path loss of the first downlink signal and the path loss of the second downlink signal fails to meet a threshold value. A new uplink timing is used when the difference meets the threshold value.

Another aspect discloses a computer program product for wireless communications in a wireless network having a computer-readable medium. The computer-readable medium has non-transitory program code recorded thereon which, when executed by the processor(s) causes the processor(s) to perform operations of measuring and recording a path loss of a first downlink signal from a source base station, prior to attempting handoff from the source base station to a target base station. The program code also causes the processor(s) to measure a path loss of a second downlink signal from the source base station, after unsuccessful handoff from the source base station to the target base station. The program code causes the processor(s) to communicate with the source base station, after unsuccessful handoff, using an uplink timing corresponding to an uplink timing recorded prior to attempting handoff when a difference between the path loss of the first downlink signal and the path loss of the second downlink signal fails to meet a threshold value, and using a new uplink timing when the difference meets the threshold value

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram illustrating an example of a telecommunications system.

FIG. 2 shows a frame structure for a TD-SCDMA carrier.

FIG. 3 is a block diagram of a Node B in communication with a user equipment in a radio access network.

FIG. 4 is a functional block diagram illustrating example blocks executed to implement one aspect of the present teachings.

FIG. 5 is a block diagram conceptually illustrating the handover scheme configured according to some aspects of the present disclosure.

FIG. 6 is a diagram illustrating an example of a hardware implementation for an apparatus employing a call recovery system in TD-SCDMA handover failure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

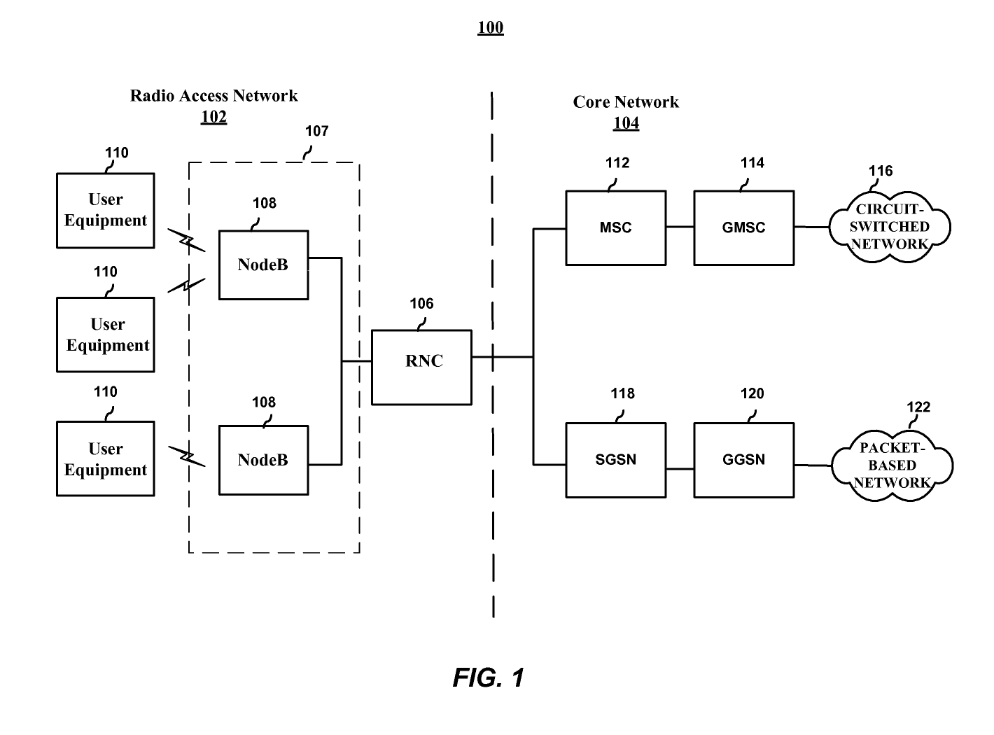

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs), such as an RNS 107, each controlled by a Radio Network Controller (RNC), such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces, such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

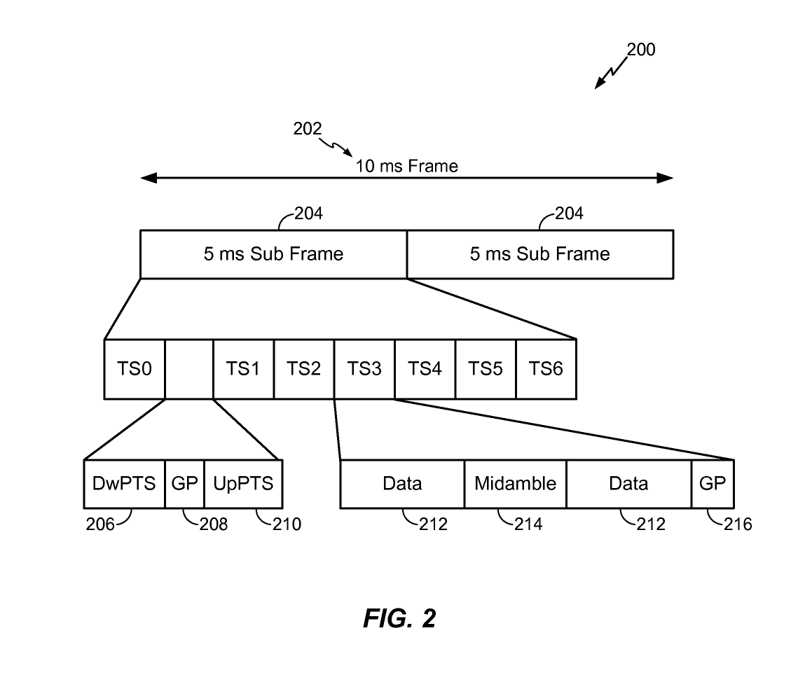

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or the downlink directions. A downlink pilot time slot (DwPTS) 206 (also known as the downlink pilot channel (DwPCH)), a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

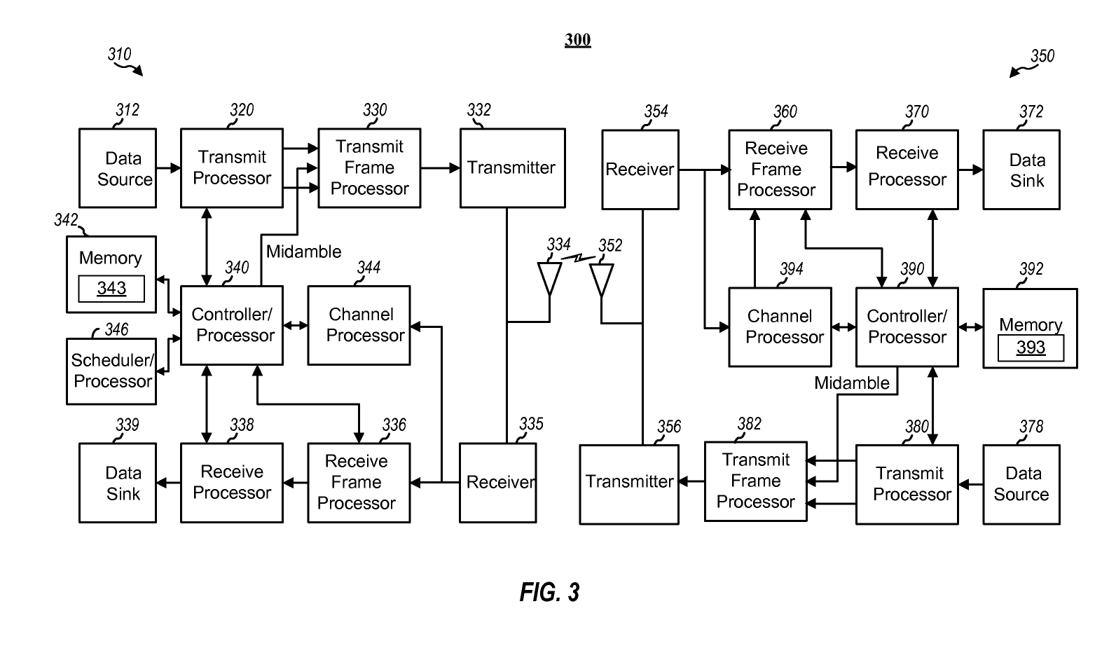

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard, pointing device, track wheel, and the like). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the smart antennas 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor 340, respectively. If some of the frames were unsuccessfully decoded by the receive processor 338, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. For example, the memory 342 of the Node B 310 includes a handover module 343, which, when executed by the controller/processor 340, the handover module 343 configures the Node B to perform handover procedures from the aspect of scheduling and transmission of system messages to the UE 350 for implementing a handover from a source cell to a target cell. The UE may also have a handover module 393 stored in its memory 392 which configures the UE to perform handover procedures with one or more Node Bs. A scheduler/processor 346 at the Node B 310 may be used to allocate resources to the UEs and schedule downlink and/or uplink transmissions for the UEs not only for handovers, but for regular communications as well.

### Call Recovery in TD-SCDMA Handover Failure

Conventional handover implementations suffer from handover attempt failure. Such handover attempt failure may result in throughput loss and detrimentally impact the perception of a user on a radio communications network. In the case of handover failure, 3GPP and China Communications Standards Association (CCSA) specifications provide for recovering a call or communication in the source cell, base station or Node B using the same resources including time slots and codes. These CCSA and 3GPP specifications, do not define an uplink (UL) timing used to reestablish the call or communication in the source cell during a failed handover. When the handover attempt fails, an uplink timing prior to the handover attempt, may no longer be valid. As a result, reestablishment of communication with the source cell or source Node B may fail due to the invalid uplink timing.

Some conventional handover implementations apply random access based recovery in the event of a handover attempt failure. In the random access based recovery implementation, the user equipment initiates a random access recovery procedure by transmitting or sending an uplink preamble sequence to the source cell by an uplink physical synchronization channel (UpPCH). When the source cell or the source Node B detects the UpPCH transmission from the user equipment, the source cell measures the uplink timing based on the detected uplink preamble sequence. The source Node B then transmits the uplink timing information to the user equipment through a fast physical access channel (FPACH). The reception of the uplink timing information at the user equipment indicates that the user equipment's UpPCH sequence has been accepted by the source Node B and the user equipment adjusts its uplink timing accordingly.

Although communication between the user equipment and the source Node B can be accurately recovered based on the above described conventional implementation, the recovery may be subject to delay or increased latency. For example, if the user equipment originates a connection in cell A and hands over the connection to cell B, then in the case of a failed handover attempt from cell B to cell C, the user equipment may not acquire a random access configuration/parameter for cell B. In this case, the user equipment acquires system information blocks (SIBs) from the source cell B to facilitate reestablishment of the connection. Acquiring system information blocks further increases the latency of recovering the connection. Further, the delay may be due to the user equipment having to compete with other user equipments to reacquire uplink resources to support its radio connections. This delay can be substantial depending on the demand for radio resources in the source cell. The present disclosure provides a system and apparatus for avoiding and/or minimizing delay issues associated with reestablishing connection due to a failed handover attempt.

One aspect of the present disclosure enables a user equipment (UE) to more efficiently establish or re-establish a connection in the radio communications network after a handover or handoff attempt failure. In particular, the user equipment measures and records a path loss of a first downlink signal of a source base station (e.g., source Node B) before a handover attempt from the source base station to a target base station (e.g., target Node B). The user equipment also measures a path loss of a second downlink signal of the source base station after an unsuccessful handover attempt from the source base station to the target base station. The first and the second downlink signals may be on the same channel, (e.g., primary common control physical channel (PCCPCH)), but at different allocated times or time slots. If the difference between the path loss measurement of the first downlink signal and the path loss measurement of the second downlink signal fails to meet a threshold value, the UE communicates with the source base station, after unsuccessful handover, using an uplink timing corresponding to an uplink timing recorded prior to attempting handoff.

If the difference between the path loss measurement of the first downlink signal and the path loss measurement of the second downlink signal meets the threshold value, the UE communicates with the source base station, after unsuccessful handoff, using a new uplink timing. The new uplink timing results from a random access based recovery implementation to recover the connection in the radio communication network. In particular, the user equipment sends an uplink synchronization code or uplink preamble sequence to the source base station. The source base station obtains the uplink timing based on a preamble measurement associated with the uplink preamble sequence and informs the user equipment of the new uplink timing via a fast physical access channel (FPACH).

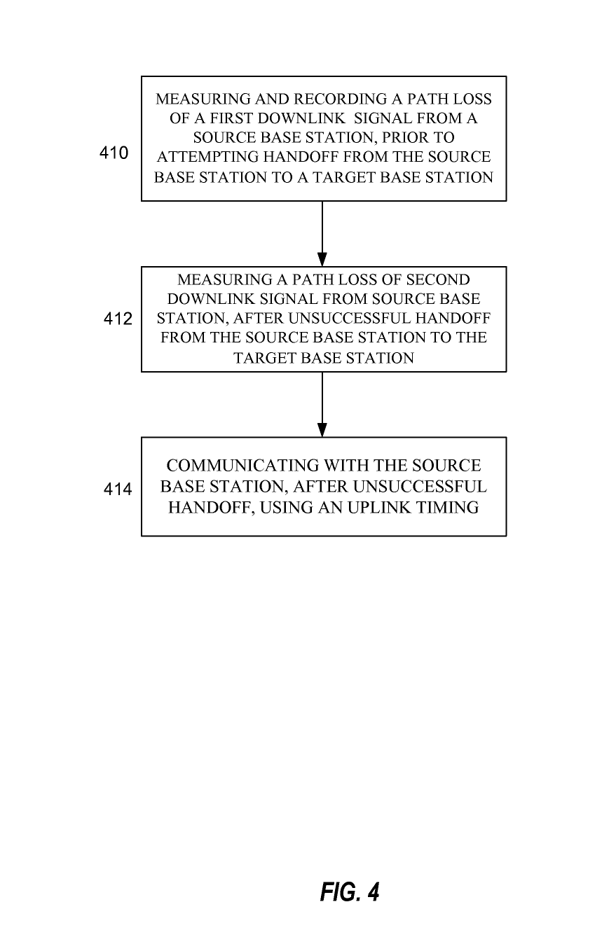

FIG. 4 is a functional block diagram illustrating example blocks executed to implement a method according to one aspect of the present teachings. At block 410, a UE measures and records a path loss of a first downlink signal from a source base station prior to attempting handoff from the source base station to a target base station. At block 412, the UE measures a path loss of a second downlink signal from the source base station after unsuccessful handoff from the source base station to the target base station. Next, at block 414, the UE communicates with the source base station, after unsuccessful handoff, using an uplink timing corresponding to an uplink timing recorded prior to attempting handoff when a difference between the path loss of the first downlink signal and the path loss of the second downlink signal fails to meet the threshold value. A new uplink timing is used when the difference meets the threshold value.

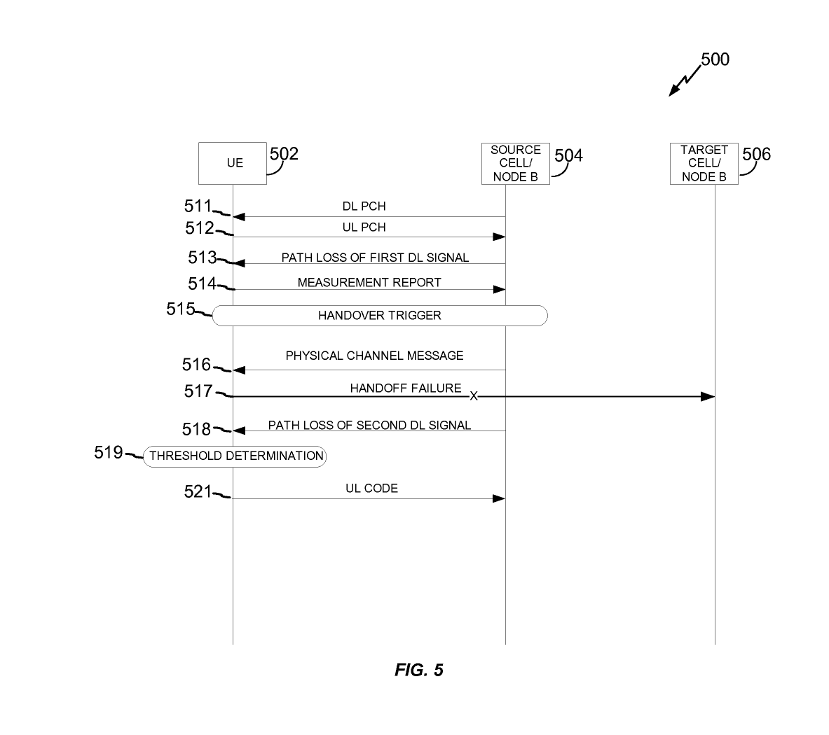

FIG. 5 is a block diagram conceptually illustrating the handover scheme configured according to some aspects of the present disclosure. The block diagram represents a scheme that enables a user equipment to efficiently establish or re-establish a connection in the radio communications network after a handover attempt failure. A TD-SCDMA communications system 500 includes a user equipment 502 in communication with a source base station, such as source Node B 504. The user equipment 502 is to be handed over to a target base station, such as the target Node B 506. Assuming that a wireless connection is already established between the user equipment 502 and the source Node B 504, at times 511 and 512 in the call flow, the user equipment communicates in both uplink and downlink directions with the source Node B 504. The communication may be over physical channels, e.g., a downlink physical channel (DL PCH) and an uplink physical channel (UL PCH).

At time 513, the user equipment measures and records a path loss of a first downlink signal from the source Node B 504, prior to attempting handover from the source Node B 504 to the target Node B 506. In some aspects, the UE continuously (or periodically) measures the path loss based on a downlink channel having a transmit power known at the UE.

The handover decision may be based on a measurement report received at the source Node B 504 from the user equipment 502, at time 514. The measurement report may include a wireless signal strength indication from an adjacent cell, a user equipment power measurement, path loss information and the like. At time 515, the measurement report may trigger a decision to hand the connection over from the source Node B 504 to the target Node B 506 resulting in initiation of a handoff procedure. In one aspect, at time 516, the handover is triggered in a physical channel message from the source Node B 504 to the user equipment 502. At time 517, an unsuccessful handoff attempt of the user equipment 502 to the target Node B 506 occurs.

At time 518, the user equipment 502 measures a path loss of a second downlink signal from the source Node B 504 after the unsuccessful handover attempt from the source Node B 504 to the target Node B 506. The first downlink signal and the second downlink signal may be on the same channel, e.g., primary common control physical channel (PCCPCH), but at different allocated times or time slots. At time 519, the user equipment 502 determines whether a difference between the path loss of the first downlink signal (measured at time 513) and the path loss of the second downlink signal (measured at time 518) meets or exceeds a predetermined threshold value. Larger path loss differences may indicate an uplink timing mismatch or that the uplink timing measured is different from the uplink timing prior to the handoff attempt. At time 521, the user equipment 502 communicates with the source base station 504, after the unsuccessful handover attempt, using an appropriate uplink timing.

The uplink timing corresponds to an uplink timing recorded prior to attempting the handover when the difference is below or does not meet the predetermined threshold value. Otherwise, when the difference meets or exceeds the predetermined threshold value, the user equipment 502 communicates with the source Node B 504, after the unsuccessful handover, using a new uplink timing. The new uplink timing is based on random access procedures with the Node B 504. At time 521, the user equipment 502 communicates with the source Node B 504 using the selected uplink timing. In some aspects, the UE 502 sends a synchronous uplink (SYNC UL) code on a physical random access channel (PRACH) to the Node B 504 using the selected uplink timing and the Node B 504, which replies with a fast physical access channel (FPACH) message to the UE.

By selecting the appropriate uplink timing, the latency of recovering from a failed handover is reduced. Moreover, the success rate of recovering from a failed handover is improved. Thus, user perception of a failed handover is less likely and throughput loss is reduced.

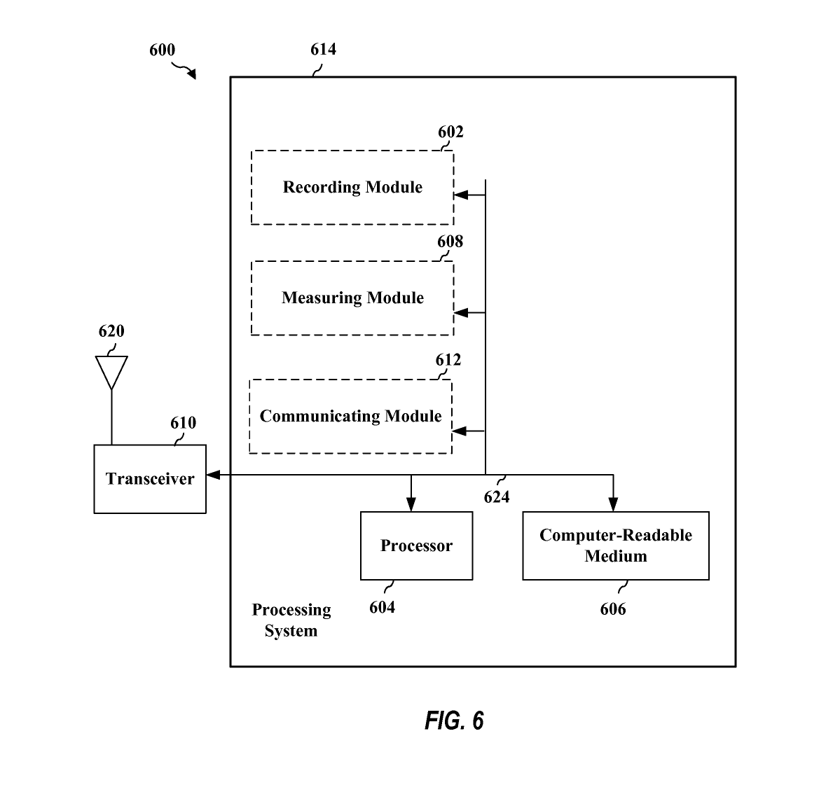

FIG. 6 is a diagram illustrating an example of a hardware implementation for an apparatus 600 employing a call recovery system 614 in TD-SCDMA handover failure. The call recovery system 614 in TD-SCDMA handover failure may be implemented with a bus architecture, represented generally by a bus 624. The bus 624 may include any number of interconnecting buses and bridges depending on the specific application of the call recovery system 614 and the overall design constraints. The bus 624 links together various circuits including one or more processors and/or hardware modules, represented by a processor 604, a measuring module 608, a recording module 602 and a communicating module 612, and a computer-readable medium 606. The bus 624 may also link various other circuits such as timing sources, peripherals, voltage regulators, and power management circuits, which are well known in the art, and therefore, will not be described any further.

The apparatus includes the call recovery system 614 coupled to a transceiver 610. The transceiver 610 is coupled to one or more antennas 620. The transceiver 610 provides a means for communicating with various other apparatus over a transmission medium. The call recovery system 614 includes the processor 604 coupled to the computer-readable medium 606. The processor 604 is responsible for general processing, including the execution of software stored on the computer-readable medium 606. The software, when executed by the processor 604, causes the call recovery system 614 to perform the various functions described supra for any particular apparatus. The computer-readable medium 606 may also be used for storing data that is manipulated by the processor 604 when executing software. The call recovery system 614 further includes the recording module 602, the measuring module 608 and the communicating module 612. The recording module 602, the measuring module 608 and the communicating module 612 may be software modules running in the processor 604, resident/stored in the computer readable medium 606, one or more hardware modules coupled to the processor 604, or some combination thereof. The call recovery system 614 may be a component of the UE 350 and may include the memory 392 and/or the transmit processor 380, the receive processor 370, the channel processor 394 and the controller/processor 440.

In one configuration, the apparatus 600 for wireless communication includes means for measuring and recording a path loss of a first downlink signal from a source base station, prior to attempting handoff from the source base station to a target base station. The measuring and recording means may be the measuring module 608, the recording module 602 and/or the call recovery system 614 of the apparatus 600 configured to perform the functions recited by the measuring and recording means. As described above, the call recovery system 614 may include the memory 392 and/or the transmit processor 380, the receive processor 370, the channel processor 394 and the controller/processor 440. In another aspect, the aforementioned means may be any module or any apparatus configured to perform the functions recited by the aforementioned means.

The apparatus 600 for wireless communication may also include means for measuring a path loss of a second downlink signal from the source base station, after unsuccessful handoff from the source base station to the target base station. The measuring means may be the measuring module 608 and/or the call recovery system 614 of the apparatus 600 configured to perform the functions recited by the measuring means. As described above, the call recovery system 614 may include the memory 392 and/or the transmit processor 380, the receive processor 370, the channel processor 394 and the controller/processor 440. In another aspect, the aforementioned means may be any module or any apparatus configured to perform the functions recited by the aforementioned means.

The apparatus 600 for wireless communication may also include means for communicating with the source base station, after unsuccessful handoff, using an uplink timing. The communicating means may be the communicating module 612 and/or the call recovery system 614 of the apparatus 600 configured to perform the functions recited by the recording means. As described above, the call recovery system 614 may include the memory 392 and/or the transmit processor 380, the receive processor 370, the channel processor 394 and the controller/processor 440. In another aspect, the aforementioned means may be any module or any apparatus configured to perform the functions recited by the aforementioned means.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform. For example, the handover module 343 stored on the memory 342 of the Node B 310, or the handover module 393 stored on the memory 392 of the UE 350, includes program logic, which may be executed by the controller/processor 340 to perform the handover functionalities described herein.

It should be noted that in the aspects of the present teachings in which the current handover functionality is implemented, the handover modules 343 and 393 include program code and software logic functions that enable this handover functionality.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
measuring and recording a path loss of a first downlink signal from a source base station, prior to attempting handoff from the source base station to a target base station;
measuring a path loss of a second downlink signal from the source base station, after unsuccessful handoff from the source base station to the target base station; and
communicating with the source base station, after unsuccessful handoff, using an uplink timing corresponding to an uplink timing recorded prior to attempting handoff when a difference between the path loss of the first downlink signal and the path loss of the second downlink signal fails to meet a threshold value, and using a new uplink timing when the difference meets the threshold value.

2. The method of claim 1, further comprising determining the new uplink timing based on a random access procedure.

3. The method of claim 2, in which the determining comprises sending a predefined sequence to the source base station and receiving the new uplink timing based on a preamble measurement.

4. The method of claim 1, in which the first downlink signal and the second downlink signal are transmitted in different time slots on a same physical channel.

5. The method of claim 4, in which the physical channel comprises a primary common control physical channel (PCCPCH).

6. An apparatus for communicating in a wireless network, comprising:
means for measuring and recording a path loss of a first downlink signal from a source base station, prior to attempting handoff from the source base station to a target base station;
means for measuring a path loss of a second downlink signal from the source base station, after unsuccessful handoff from the source base station to the target base station; and
means for communicating with the source base station, after unsuccessful handoff, using an uplink timing corresponding to an uplink timing recorded prior to attempting handoff when a difference between the path loss of the first downlink signal and the path loss of the second downlink signal fails to meet a threshold value, and using a new uplink timing when the difference meets the threshold value.

7. The apparatus of claim 6, further comprising means for determining the new uplink timing based on a random access procedure.

8. The apparatus of claim 7, in which the determining means comprises means for sending a predefined sequence to the source base station and receiving the new uplink timing based on a preamble measurement.

9. The apparatus of claim 6, further comprising means for transmitting the first downlink signal and the second downlink signal in different time slots on a same physical channel.

10. The apparatus of claim 9, in which the physical channel comprises a primary common control physical channel (PCCPCH).

11. An apparatus for communicating in a wireless network, comprising:
a memory; and
at least one processor coupled to the memory and configured:
to measure and record a path loss of a first downlink signal from a source base station, prior to attempting handoff from the source base station to a target base station;
to measure a path loss of a second downlink signal from the source base station, after unsuccessful handoff from the source base station to the target base station; and
to communicate with the source base station, after unsuccessful handoff, using an uplink timing corresponding to an uplink timing recorded prior to attempting handoff when a difference between the path loss of the first downlink signal and the path loss of the second downlink signal fails to meet a threshold value, and using a new uplink timing when the difference meets the threshold value.

12. The apparatus of claim 11, in which the at least one processor is further configured to determine the new uplink timing based on a random access procedure.

13. The apparatus of claim 12, in which the at least one processor is further configured to determine by sending a predefined sequence to the source base station and receiving the new uplink timing based on a preamble measurement.

14. The apparatus of claim 11, in which the at least one processor is further configured to transmit the first downlink signal and the second downlink signal in different time slots on a same physical channel.

15. The apparatus of claim 14, in which the physical channel comprises a primary common control physical channel (PCCPCH).

16. A computer program product for wireless communications in a wireless network, comprising:
a computer-readable medium having non-transitory program code recorded thereon, the program code comprising:
program code to measure and record a path loss of a first downlink signal from a source base station, prior to attempting handoff from the source base station to a target base station;
program code to measure a path loss of a second downlink signal from the source base station, after unsuccessful handoff from the source base station to the target base station; and
program code to communicate with the source base station, after unsuccessful handoff, using an uplink timing corresponding to an uplink timing recorded prior to attempting handoff when a difference between the path loss of the first downlink signal and the path loss of the second downlink signal fails to meet a threshold value, and using a new uplink timing when the difference meets the threshold value.

17. The computer program product of claim 16, further comprising program code to determine the new uplink timing based on a random access procedure.

18. The computer program product of claim 17, in which the program code determines by sending a predefined sequence to the source base station and receiving the new uplink timing based on a preamble measurement.

19. The computer program product of claim 16, further comprising program code to transmit the first downlink signal and the second downlink signal in different time slots on a same physical channel.

20. The computer program product of claim 19, in which the physical channel comprises a primary common control physical channel (PCCPCH).
